(19) United States
(12) Patent Application Publication
(10) Pub. No.: US 2009/0248918 A1
(43) Pub. Date: Oct. 1, 2009

(54) METHOD AND SYSTEM FOR A USB ETHERTYPE TO TUNNEL USB OVER ETHERNET

(76) Inventors: Wael William Diab, San Francisco, CA (US); Howard Millard Frazier, Pleasanton, CA (US)

Correspondence Address: MCANDREWS HELD & MALLOY, LTD, 500 WEST MADISON STREET, SUITE 3400, CHICAGO, IL, 60661, US

(21) Appl. No.: 12/056,445

(22) Filed: Mar. 27, 2008

(51) Int. Cl. G06F 3/00

(52) U.S. Cl. 710/51

(57) ABSTRACT

Aspects of a method and system for USB Ethertype to tunnel USB over Ethernet are provided. In this regard, Ethernet frames comprising USB traffic may be identified via one or more headers in the Ethernet frames and the USB traffic may be processed according to the identification. In this regard, USB traffic and general Ethernet traffic may be multiplexed into egress frames based on the identification. Similarly, ingress Ethernet frames may be demultiplexed into USB traffic and general traffic based on the identification. Headers utilized to identify and/or route USB traffic and general traffic may comprise Ethertype and/or subtype fields. The subtype field may comprise information pertaining to a USB bus to which the traffic belongs and/or a version of the USB standard to which the traffic adheres.

### CROSS-REFERENCE TO RELATED APPLICATIONS/INCORPORATION BY REFERENCE

Not Applicable

### FIELD OF THE INVENTION

Certain embodiments of the invention relate to signal processing. More specifically, certain embodiments of the invention relate to a method and system for a USB Ethertype to tunnel USB over Ethernet.

### BACKGROUND OF THE INVENTION

Universal serial bus (USB) is a serial bus standard designed to provide a standard and reliable interface between electronic devices. In recent years, the “plug and play” nature of USB has led the standard to enormous commercial success. In fact, USB has become a nearly ubiquitous means for connecting electronic devices of all types, sizes and shapes. In this regard, input devices such as keyboards and mice, mass storage devices, cell phones, and portable music players are just some of the devices which commonly comprise a USB interface.

USB provides an almost ideal connectivity solution for electronic devices to interface with other devices in a common locality. USB is not, however, well suited for connecting devices over long distances. In this regard, USB is a high-speed, time-sensitive standard which does not deal well with latencies, delays, and signal integrity issues experienced in most conventional networks.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a USB Ethertype to tunnel USB over Ethernet, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary system enabled to transmit and/or receive USB traffic over Ethernet utilizing a USB Ethertype, in accordance with an embodiment of the invention.

FIG. 2 is a diagram illustrating transmission of USB traffic over an Ethernet network, in accordance with an embodiment of the invention.

FIG. 3A is a diagram of an exemplary Ethernet frame comprising USB traffic, in accordance with an embodiment of the invention.

FIG. 3B is a diagram of an exemplary VLAN tagged Ethernet frame comprising USB traffic, in accordance with an embodiment of the invention.

FIG. 4 is a logical diagram of the flow of Ethernet frames comprising USB traffic to/from a network node, in accordance with an embodiment of the invention.

### DETAILED DESCRIPTION OF THE INVENTION

Certain embodiments of the invention may be found in a method and system for a USB Ethertype to tunnel USB traffic over Ethernet. In this regard, Ethernet frames comprising USB traffic may be identified via one or more headers in an Ethernet frame and the USB traffic may be processed according to the identification. In this regard, USB traffic and general Ethernet traffic may be multiplexed into egress frames based on the identification. Similarly, ingress Ethernet frames may be demultiplexed into USB traffic and general traffic based on the identification. Headers utilized to identify and/or route USB traffic and general traffic may comprise Ethertype and/or subtype fields. The subtype field may comprise information for identifying which USB bus the traffic belongs to and/or a version of the USB standard to which the traffic adheres.

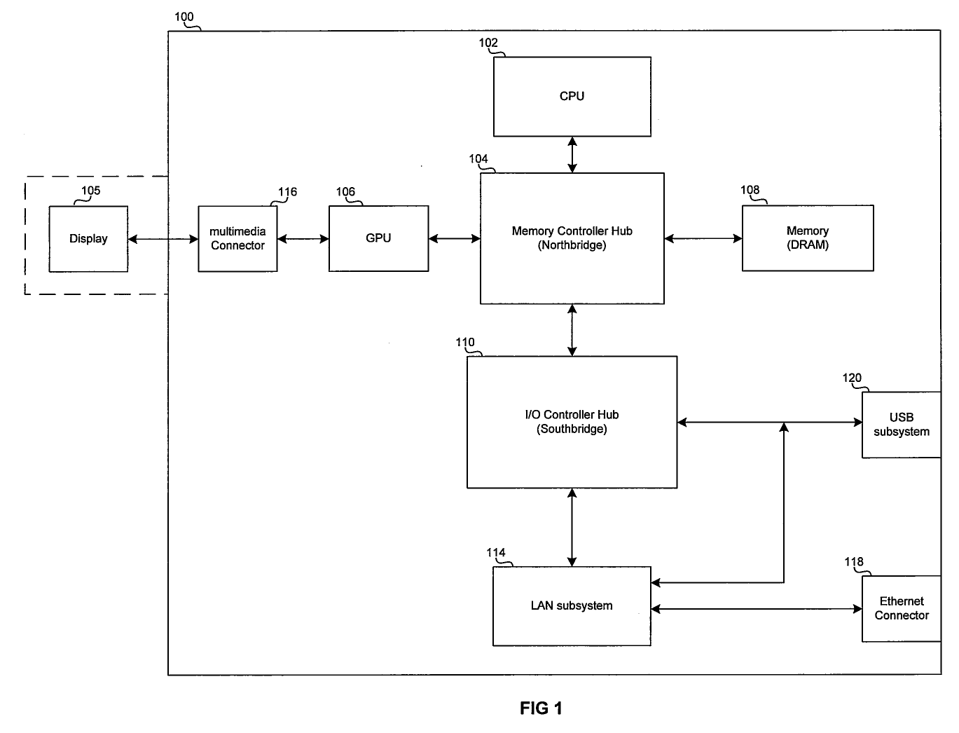

FIG. 1 is a diagram illustrating an exemplary system enabled to transmit and/or receive USB traffic over Ethernet utilizing a USB Ethertype, in accordance with an embodiment of the invention. Referring to FIG. 1 the system 100 may comprise a CPU 102, a memory controller hub (MCH) 104, a graphics processing unit (GPU) 106, a memory block 108, an input/output controller hub (ICH) 110, a low speed peripheral block 112, a LAN subsystem 114, a multimedia connector 116, an Ethernet connector 118a, an Ethernet connector 118b and USB subsystem 120.

The CPU 102 may comprise suitable logic, circuitry, and/or code that may enable processing data and/or controlling operations of the system 100. In this regard, the CPU 102 may be enabled to provide control signals to the various other blocks comprising the system 100. The CPU 102 may also enable execution of applications programs and/or code. The applications, programs, and/or code may receive, generate, and/or process commands, instructions, and/or data conveyed via a universal serial bus (USB). The CPU 102 may be accessed via the MCH 104.

The MCH 104 may comprise suitable logic, circuitry, and/or code that may enable the storage and/or retrieval of data at high data transfer rates. For example, the MCH 104 may enable retrieval and/or storage of uncompressed video and/or graphics data for high performance applications, such as high definition video, high resolution 3-D graphics, etc. In various embodiments of the invention, the MCH 104 may be referred to as a northbridge (NB).

The GPU 106 may comprise suitable logic, circuitry, and/or code for generating, rendering, and/or manipulating graphics data. The GPU 106 may output uncompressed video and/or graphics. The GPU 106 may also output encrypted uncompressed video and/or graphics for applications that utilize digital content protection, for example. The GPU 106 may encapsulate the video and/or graphics into protocol data units (PDUs) and output the PDUs to the multimedia connector 116 and/or the LAN subsystem 114.

The memory 108 may comprise suitable logic, circuitry, and/or code that may enable the storage and/or retrieval of data. For example, the memory 108 may store configuration data and/or state variables utilized in controlling/configuring the various blocks of the system 100. The memory 108 may also enable the storage of code, which enables the execution of applications, for example. The memory 108 may utilize various technologies, such as dynamic random access memory (DRAM), which enable data to be stored and/or retrieved at sufficiently high data rates to enable high performance applications, for example.

The ICH 110 may comprise suitable logic, circuitry, and/or code that may enable the storage and/or retrieval of data from peripheral devices. In this regard, the ICH 110 may interface to one or more universal serial busses. Accordingly, the ICH 110 may also enable communicating signals and/or data to and/or from USB connected devices such as input devices (keyboard, mouse, microphone, etc.), external storage devices (flash drive, hard drive, etc), and/or other peripheral devices. Thus, the ICH 110 may be enabled to convert between data packetized and/or formatted according to the USB standard and data packetized and/or formatted according to standards utilized by the LAN subsystem 114 and/or the MCH 104. In various embodiments of the invention, the ICH 110 may be referred to as a southbridge (SB).

The USB subsystem 120 may comprise suitable logic, circuitry and/or code for communicatively coupling to one or more peripheral devices according to universal serial bus (USB) standards. In this regard, the USB subsystem 120 may comprise, for example, a USB controller and one or more USB ports.

The LAN subsystem 114 may comprise suitable logic, circuitry, and/or code to enable the transmission and/or reception of Ethernet frames. The LAN subsystem 114 may comprise PHY layer functions and MAC layer functions. The LAN subsystem 114 may enable transmission and/or reception of Ethernet frames at various transfer rates, such as standardized rates of 10 Mbps, 100 Mbps, 1 Gbps, 10 Gbps, 40 Gbps, or 100 Gbps, and/or other standardized or non-standardized rates such as 2.5 Gbps, 5 Gbps, etc. The LAN subsystem 114 may also enable transmission and/or reception of Ethernet frames via wireless LANs (WLAN). In various embodiments of the invention, the LAN subsystem 114 may be enabled to receive USB data, encapsulate that USB data into one or more Ethernet frames, and transmit those Ethernet frames to a remote node. In this regard, the USB traffic may be received via the southbridge or may be received from the USB subsystem 120, in which case the LAN subsystem 114 may be enabled to perform USB to Ethernet conversion. In various embodiments of the invention, the USB data may or may not be buffered prior to transmitting it over an Ethernet link.

Since USB traffic may be time sensitive, various embodiments of the invention may utilize Audio Video Bridging Protocols and/or extensions thereto when communicating the USB traffic to a remote node, however other embodiments may not utilize or require AVB. Moreover, aspects of the invention may enable utilizing a distinct USB Ethertype to identify the Ethernet frame(s) as comprising USB data. In this manner, nodes receiving the Ethernet frames may identify the frames as comprising USB data and process the frames accordingly. Thus, aspects of the invention may enable communicating USB traffic over a network such that the conversion to and from Ethernet is transparent to the USB connected devices.

The PHY layer functions may enable transmission of Ethernet frames via a communication medium. The PHY layer functions may also enable reception of Ethernet frames via the communication medium. The PHY layer functions may generate signals for transmission that are suitable for the physical medium being utilized for transmitting the signals. For example, for an optical communication medium, the PHY layer may generate optical signals, such as light pulses, or for a wired communication medium, the PHY layer may generate electromagnetic signals.

The MAC layer functions may enable orderly communication between systems that are communicatively coupled via a shared communication medium. The MAC layer may comprise one or more coordination functions (CF) that enable a system to determine when it may attempt to access the shared communication medium. For example, in a wired communication medium, for example Ethernet, a CF may utilize a carrier sense multiple access with collision detection (CSMA/CD) algorithm. The MAC layer functions may implement mechanisms for scanning the communication medium to determine when it is available for transmission of signals. The MAC layer functions may comprise back off timer mechanisms, which may be utilized by a system to determine how often to attempt to access a communication medium, which is currently determined to be unavailable.

The MAC layer functions may also enable AV Bridging capabilities. In this regard, the MAC layer functions may determine a traffic class which is associated with transmitted Ethernet frames. Based on the determined traffic class, the MAC layer functions may perform traffic shaping by determining a time instant at which an Ethernet frame may be sent to the network via the Ethernet interface. That time instant may be determined based on a time instant at which one or more preceding Ethernet frames were also transmitted via the Ethernet interface. The time instant may also be determined based on stored “credits”, which may indicate a quantity of octets of Ethernet frame data that may be transmitted at “line rate” before transmission of subsequent Ethernet frames is suspended pending the accumulation of additional credits.

The MAC layer functions, which support AV Bridging, may also enable the end-to-end transport of Ethernet frames based on specified latency targets by initiating admission control procedures. The latency targets, which may specify a maximum time duration for the transport of Ethernet frame across the network, may be determined based on a specified traffic class. For example, USB traffic may need to travel from a source to destination within a determined amount of time. Ethernet frames comprising USB traffic, as indicated by a distinct USB Ethertype, may be processed accordingly by network nodes. A destination Ethernet device may initiate admission control procedures by initiating a registration request across the network to the source Ethernet device. A successful registration may enable the network to reserve resources for the transport of Ethernet frames between the source Ethernet device and the destination Ethernet device, in accordance with the specified latency targets.

The Ethernet MAC layer functions may also enable an exchange of timing synchronization information between communicating Ethernet devices. Individual Ethernet MAC layer functions associated with each of a plurality of Ethernet devices within a LAN may exchange timing synchronization with the Ethernet MAC layer function associated with a specified Ethernet device associated with the LAN, wherein the specified Ethernet device may provide system timing for the plurality of Ethernet devices associated with the LAN. The traffic shaping and/or timing synchronization capabilities may enable AV Bridging services to support isochronous and/or real time services, such as streaming media services.

In various embodiments of the invention, the MAC layer functions within the LAN subsystem 114 may enable the reception of USB packets and encapsulation of the received USB packets within Ethernet frames. The Ethernet frames may utilize AV Bridging services when being transmitted via a network. Additionally, the Ethertype field of the Ethernet frames may be populated with a distinct Ethertype indicating that the frames comprise USB traffic. The MAC layer functions within the LAN subsystem 114 may also enable the reception of Ethernet frames and the de-encapsulation of USB packets from Ethernet frames, which are determined to contain encapsulated USB packets.

In various embodiments of the invention, the LAN subsystem 114 may utilize code, such as firmware, and/or data stored within the memory 108 to enable the operation of MAC layer functions and/or PHY layer functions within an Ethernet LAN, for example. The firmware may also enable encapsulation of USB packets in Ethernet frames within the LAN subsystem 114. In addition, the firmware may enable de-encapsulation of USB packets from Ethernet frames.

The multimedia interface connector 116 may enable physical connection to a multimedia interface, such as DVI, HDMI, or DisplayPort. In one embodiment of the invention, connector 116 may be a DisplayPort connector and the physical link may comprise at least conductors for each of the 4 lanes in the Display Port interface and for an auxiliary (AUX) lane. The 4 video lanes may enable the transmission or reception of Display Port mini-packets containing video data, while the AUX lane may enable transmission and reception of audio signals, control signals, input from peripheral devices such as keyboards and/or mice, and encryption keys. In various embodiments of the invention, the multimedia interface connector 116 may connect the system 100 to a display 105, which may be part of the system 100 or may be an external display communicatively coupled to the system 100.

The Ethernet connector 118 may enable physical connection to an Ethernet Physical link which may comprise, for example, one or more twisted pairs. The Ethernet connector 118 may enable physical connection via an 8P8C modular connector, such as a RJ-45 connector, for example. In various embodiments of the invention, the Ethernet connector 118 may provide a physical connection to enable communication of general Ethernet traffic, and/or USB traffic, utilizing A/V Bridging protocols and/or extensions thereto, between the system 100 and a remote system.

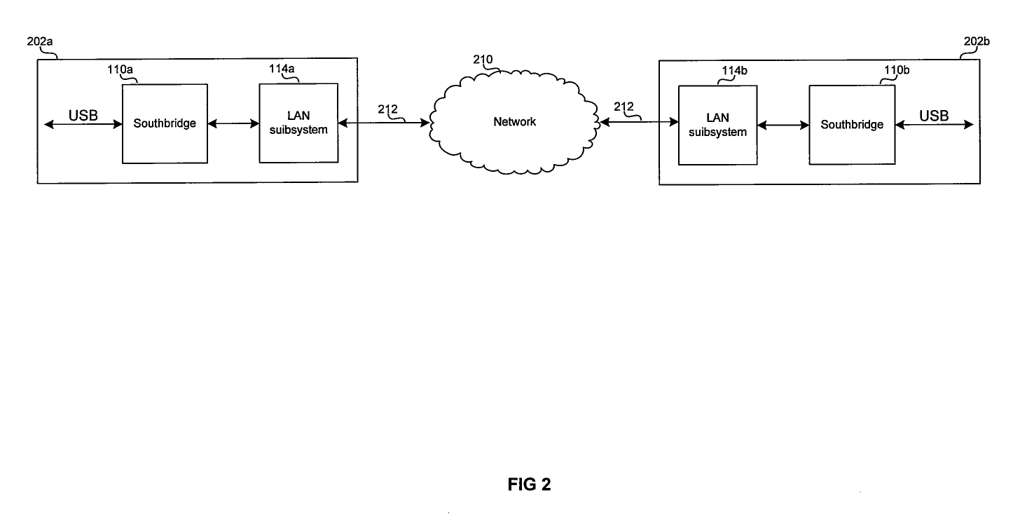

FIG. 2 is a diagram illustrating transmission of USB traffic over an Ethernet network, in accordance with an embodiment of the invention. Referring to FIG. 2 there is shown network nodes 202a and 202b which may exchange USB traffic via the network 210. Although only two nodes are shown, various embodiments of the invention may enable communicating USB traffic among three or more nodes over one or more Ethernet links.

Each of the nodes 202a and 202b may comprise suitable logic circuitry, and/or code that may enable communicating data via a universal serial bus and in particular, communicating USB traffic over an Ethernet link. In this regard, the nodes 202a and 202b may be similar to the system 100 of FIG. 1.

The network 210 may comprise one or more physical links and/or network hardware devices. In an exemplary embodiment of the invention the network 210 may comprise one or more Ethernet switches, and/or one or more unshielded twisted pair cables with 8 position 8 conductor (8P8C) modular connectors on either end.

In an exemplary operation, the node 202a may transmit and/or receive data to/from the node 202b via the network 210. For example, a USB keyboard connected to the node 202a may be utilized for inputting data to the node 202b. Accordingly, the USB data may be communicated over one or more Ethernet links 212 of the network 210. In this regard, USB packets may be encapsulated into Ethernet frames comprising a distinct USB Ethertype. Additionally, the LAN subsystem 114a may convert the Ethernet frames to physical symbols and may convey the physical symbols onto an Ethernet link 212. Subsequently, the symbols may arrive at the LAN subsystem 114b and be reassembled into Ethernet frames. Next, the LAN subsystem 114b may identify, via the Ethertype, the Ethernet frames as comprising USB traffic. Accordingly, the USB packets may be extracted and/or reconstructed and conveyed onto a USB bus of the node 202b.

In another exemplary embodiment of the invention, the node 202b may write data to a USB storage device coupled to the node 202a. In this regard, the node 202b may generate one or more USB packets destined for the USB storage device and the USB packets may be encapsulated into one or more Ethernet frames. In this regard, an Ethertype field of the Ethernet frames may identify the frames as comprising USB traffic. Upon arriving at the LAN subsystem 114, the USB Ethertype may be identified, the USB packets may be extracted and/or reconstructed from the Ethernet frames, and the USB packets may be conveyed to the USB storage device. In this regard, the communication of the USB traffic over the network may be transparent to the USB storage device.

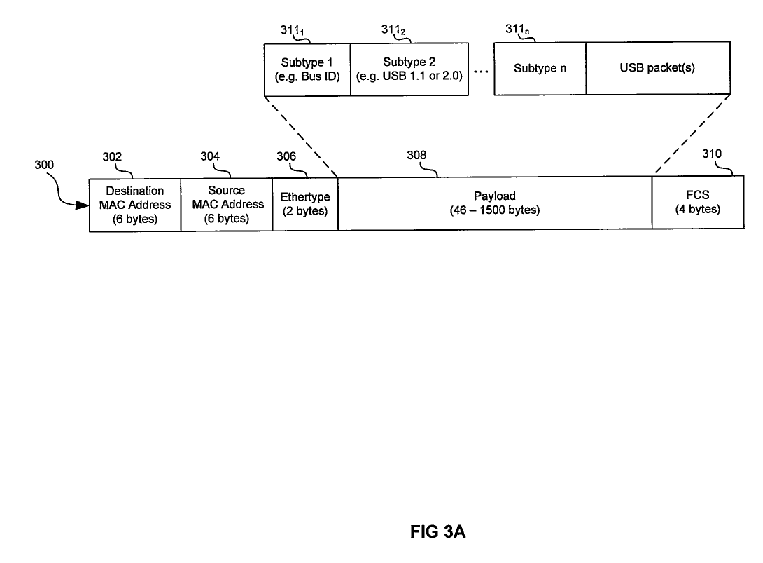

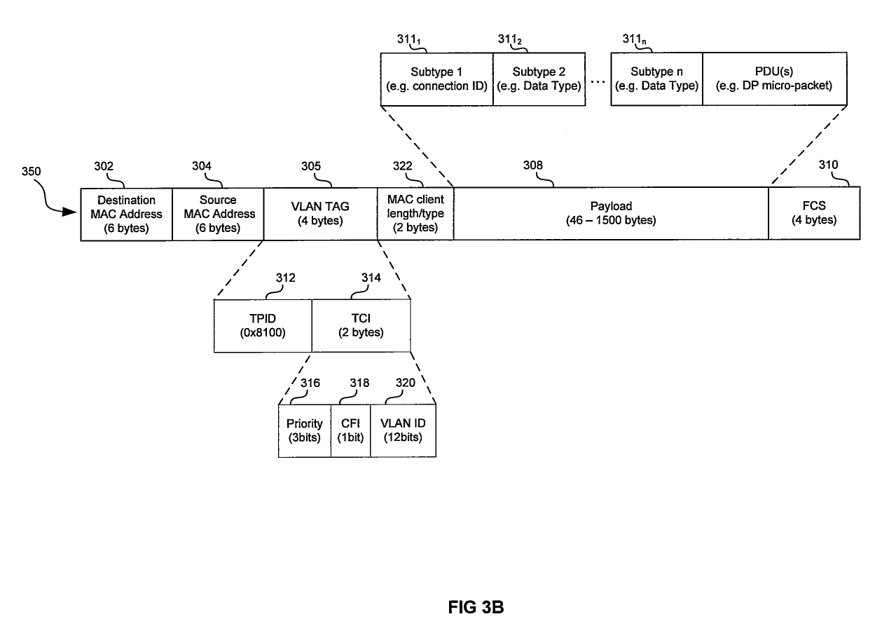

FIG. 3A is a diagram of an exemplary Ethernet frame comprising USB traffic, in accordance with an embodiment of the invention. Referring to FIG. 3A, the Ethernet frame 350 may comprise a destination MAC address field 302, a source MAC address field 304, an Ethertype field 306, a payload 308, and a frame check sequence (FCS) 310.

The destination MAC address field 302 may comprise information that may be utilized to identify the node that the packet is to be sent to. The source MAC address 304 field may comprise information that may be utilized to identify the node that originated the packet.

The Ethertype 306 may be utilized to identify the type and/or nature of the data which comprises the payload 308. In one embodiment of the invention, the Ethertype may indicate the payload 308 comprises one or more USB packets. In another embodiment of the invention, the Ethertype 306 may indicate that the payload 308 comprises one or more USB packets and may further identify the version (e.g USB 1.1 or 2.0) of the USB packets. In another embodiment of the invention, the Ethertype 306 may identify that the payload comprises USB traffic that has been encapsulated utilizing a higher layer protocol such as IP. In this regard, the information obtained from parsing the Ethertype 306 may be passed up to the IP layer so that the USB packets may be extracted and/or re-constructed from the IP datagrams.

The payload 308 may contain the data being transmitted. In one embodiment of the invention, the payload 308 may comprise one or more USB packets, or information extracted form one or more USB packets. In other embodiments of the invention, the payload 308 may comprise one or more IP datagrams and/or other protocol data units. In various embodiments of the invention, the payload may comprise up to ‘n’ subtype fields 311. In this regard, the payload may comprise a first subtype field 311₁ which may comprise, for example, a Bus ID utilized to identify a universal serial bus which originated the packets. In this manner, multiple busses may be supported over a single Ethernet link. The payload may comprise a second subtype 311₂ which may, for example, identify the version (e.g. 1.1 or 2.0) to which the USB packets adhere. In this manner a node receiving the Ethernet frame may, for example, be enabled to correctly receive and parse the USB packet(s). In various embodiments of the invention, the frame 350 may comprise different and/or additional subtypes which may be utilized to indicate additional details about the USB traffic.

The FCS 210 may comprise information that may be utilized to provide error detection for the packet. The FCS 210 may comprise, for example, a CRC or a checksum.

In an exemplary operation, when a packet such as the Ethernet frame 300 arrives at a network node, the Ethertype 306 may be parsed and the frame may be identified as comprising USB data. After parsing the Ethertype 306, the first subtype (USB ID) 311₁ may be parsed to identify which universal serial bus the frame belongs to. Subsequently, the second subtype (USB standard) 311₂ may be parsed to identify the version of the USB standard (e.g., USB 1.1 or USB 2.0) that the data adheres to. In some instances, the Ethertype field 306 may indicate whether the payload of the frame comprises USB packets directly, or if an intermediary protocol was utilized to encapsulate the USB packets. If the frame comprises an intermediary protocol data unit, such as an IP datagram, then the Ethertype 306, the connection ID 311₁, and/or the Data Type 311₂ may be passed up the protocol stack along with the protocol data unit.

FIG. 3B is a diagram of an exemplary VLAN tagged Ethernet frame comprising USB traffic, in accordance with an embodiment of the invention. Referring to FIG. 3B there is shown a frame 360 which is similar to the frame 350 but with a VLAN tag 305 inserted after the destination address 304.

The VLAN tag 305 may comprise a TPID 312 and a tag control information (TCI) field 314. The TPID 312 may comprise a numerical identifier, similar to or the same as an Ethertype, which may indicate that the frame 360 has been VLAN tagged so that the frame 360 may be parsed accordingly. An exemplary numerical identifier may comprise 0x8100. The TCI field 314 may comprise a priority field 316, a canonical format indicator (CFI) 318, and a VLAN ID 320. The CFI 318 may be used to provide compatibility between Ethernet and token ring networks. The VLAN ID 320 may comprise a numerical identifier corresponding to the VLAN with which the frame 360 is associated. The priority field 316 may indicate a level of urgency associate with the frame 360. In this regard, frames transmitted utilizing AudioNideo Bridging and/or AudioNideo Bridging Extensions (collectively referred to herein as AVB), for example, may tag frames as depicted in FIG. 3B such that the priority field may be utilized in allocating resources for AVB streams.

The MAC client length/type field 322 may be similar to or the same as the Ethertype field 306. In this regard, when the frame 360 is parsed, the VLAN tag 305 may be removed and the length/type field 322 may be shifted over and become the Ethertype 306. In this manner, when a frame is VLAN tagged, the information comprising the Ethertype field 306 may be preserved in the MAC client length/type field 322.

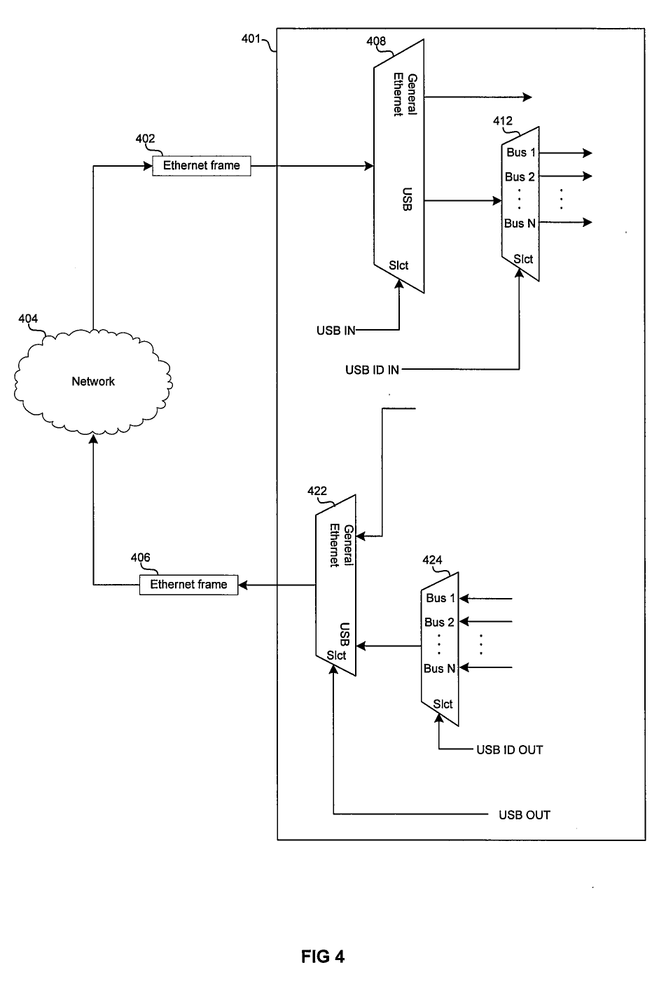

FIG. 4 is a logical diagram of the flow of Ethernet frames comprising USB traffic to/from a network node, in accordance with an embodiment of the invention. Referring to FIG. 4, there is shown a network node 401 which may transmit and/or receive USB traffic over a network 404. In this regard, USB data may be exchanged between the server 401 and one or more nodes comprising the network 404. The node 401 may transmit general Ethernet traffic as well as Ethernet frames containing USB traffic.

The switching block 424 may function in such a manner as to enable the multiplexing of multiple USB busses into egress Ethernet frames, such as the egress packet 406. In this regard, a USB bus for which data is placed into the Egress frame 406 may be selected by a USB ID OUT signal. For example, a USB ID OUT value of 1 to ‘N’ may select USB busses 1 to ‘N’, respectively. Accordingly, the value of USB ID OUT associated with a block of data may be placed into a subtype field prepended to the payload of the egress Ethernet frame 406, as illustrated in FIGS. 3A and 3B.

The switching block 422 may function in such a manner as to enable the multiplexing of USB traffic and general Ethernet traffic into egress Ethernet frames, such as the egress Ethernet frame 406. In this regard, the egress Ethernet frame 406 may comprise general Ethernet traffic or USB traffic depending on the value of the USB OUT signal. For example, the USB OUT signal being asserted may result in the egress Ethernet frame 402 comprising USB data.

The switching block 408 may function in such a manner as to enable the de-multiplexing of USB traffic and general Ethernet traffic contained in ingress Ethernet frames, such as the ingress Ethernet frame 402. In this regard, the ingress Ethernet frame 402 may be parsed and it may be determined whether the frame comprises a USB Ethertype, as in FIG. 3A. For example, if the frame 402 comprises a USB Ethertype, the frame 402 may be routed to the switching element 412. If the frame 402 does not comprise a USB Ethertype, it may be routed as general Ethernet traffic.

The switching block 412 may function in such a manner as to enable the de-multiplexing of received USB data from ‘N’ USB busses. In this regard, the ingress Ethernet frame 402 may be parsed to determine the USB bus ID and the value of USB ID IN may corresponds to the value of the USB bus ID. Accordingly, USB data contained in the ingress Ethernet frame 402 may be routed to the appropriate USB bus.

Aspects of a method and system for a USB Ethertype to tunnel USB traffic over Ethernet are provided. In this regard, Ethernet frames comprising USB traffic (e.g. frames 300 and 350 of FIGS. 3A and 3B) may be identified via one or more headers (e.g. 306, 311, 322 of FIGS. 3A and 3B) in the Ethernet frames and the USB traffic may be processed according to the identification. In this regard, USB traffic and general Ethernet traffic may be multiplexed into egress frames (e.g., frame 406 of FIG. 4) based on the identification. Similarly, ingress Ethernet frames (e.g., frame 402 of FIG. 4) may be demultiplexed into USB traffic and general traffic based on the identification. Headers utilized to identify and/or route USB traffic and general traffic may comprise Ethertype and/or subtype fields. The subtype field may comprise information pertaining to a USB bus to which the traffic belongs and/or a version of the USB standard to which the traffic adheres.

Another embodiment of the invention may provide a machine-readable storage, having stored thereon, a computer program having at least one code section executable by a machine, thereby causing the machine to perform the steps as described herein for tunneling USB over Ethernet via a USB Ethertype.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for enabling communication of information, the method comprising:
identifying an Ethernet frame comprising USB traffic via one or more fields associated with said Ethernet frame; and
one or both of multiplexing and demultiplexing said USB traffic based on said identification.

2. The method according to claim 1, comprising multiplexing general Ethernet traffic and said USB traffic into egress Ethernet frames based on said identification.

3. The method according to claim 1, comprising de-multiplexing ingress Ethernet frames into general Ethernet traffic and said USB traffic based on said identification.

4. The method according to claim 1, wherein said one or more fields comprise an Ethertype.

5. The method according to claim 1, wherein said one or more fields comprise one or more subtype fields.

6. The method according to claim 5, wherein said one or more subtype fields comprise a bus identifier.

7. The method according to claim 6, comprising multiplexing and/or de-multiplexing USB traffic based on said bus identifier.

8. The method according to claim 5, wherein said one or more subtype fields identify to which version of the USB standard said USB traffic adheres.

9. The method according to claim 1, comprising reserving resources in a network for said USB traffic via audio video bridging and/or extensions thereto.

10. A machine-readable storage having stored thereon, a computer program having at least one code section for enabling communication of information, the at least one code section being executable by a machine for causing the machine to perform steps comprising:
identifying an Ethernet frame comprising USB traffic via one or more fields associated with said Ethernet frame; and
one or both of multiplexing and demultiplexing said USB traffic based on said identification.

11. The machine-readable storage according to claim 10, wherein said at least one code section enables multiplexing general Ethernet traffic and said USB traffic into egress Ethernet frames based on said identification.

12. The machine-readable storage according to claim 10, wherein said at least one code section enables de-multiplexing ingress Ethernet frames into general Ethernet traffic and said USB traffic based on said identification.

13. The machine-readable storage according to claim 10, wherein said one or more fields comprise an Ethertype.

14. The machine-readable storage according to claim 10, wherein said one or more fields comprise one or more subtype fields.

15. The machine-readable storage according to claim 14, wherein said one or more subtype fields comprise a bus identifier.

16. The machine-readable storage according to claim 15, wherein said at least one code section enables multiplexing and/or de-multiplexing USB traffic based on said bus identifier.

17. The machine-readable storage according to claim 14, wherein said one or more subtype fields identify to which version of the USB standard said USB traffic adheres.

18. The machine-readable storage according to claim 10, wherein said at least one code section comprises code for reserving resources in a network for said USB traffic utilizing audio video bridging and/or extensions thereto.

19. A system for enabling communication of information, the system comprising:
one or more circuits that identifies an Ethernet frame comprising USB traffic via one or more fields associated with said Ethernet frame; and
said one or more circuits enables multiplexing and/or demultiplexing of said USB traffic based on said identification.

20. The system according to claim 19, wherein said one or more circuits enables multiplexing of general Ethernet traffic and said USB traffic into egress Ethernet frames based on said identification.

21. The system according to claim 19, wherein said one or more circuits enables de-multiplexing of ingress Ethernet frames into general Ethernet traffic and said USB traffic based on said identification.

22. The system according to claim 19, wherein said one or more fields comprise an Ethertype.

23. The system according to claim 19, wherein said one or more fields comprise one or more subtype fields.

24. The machine-readable storage according to claim 23, wherein said one or more subtype fields comprise a bus identifier.

25. The system according to claim 24, wherein said one or more circuits enables multiplexing and/or de-multiplexing of USB traffic based on said bus identifier.

26. The system according to claim 25, wherein said one or more subtype fields identify to which version of the USB standard said USB traffic adheres.

27. The system according to claim 19, wherein said one or more circuits reserve resources in a network for said USB traffic utilizing audio video bridging and/or extensions thereto.
